(19) United States
(12) Patent Application Publication
(10) Pub. No.: US 2020/0034530 A1
(43) Pub. Date: Jan. 30, 2020

(54) PROTECTION SYSTEM AGAINST EXPLOITATIVE RESOURCE USE BY WEBSITES

(71) Applicant: CA, Inc., New York, NY (US)

(72) Inventors: Michal Zasadzinski, Olsztyn (PL); Marc Solé Simó, Barcelona (ES); Victor Muntés-Mulero, Sant Feliu de Llobregat (ES)

(21) Appl. No.: 16/046,143

(22) Filed: Jul. 26, 2018

(51) Int. Cl. G06F 21/55; G06F 21/52

(52) U.S. Cl. CPC G06F 21/554; G06F 2221/033; G06F 21/52

(57) ABSTRACT

A browser resource controller combines code metric values with a complexity analysis of rendered content to determine whether resource metric values are appropriate for a web application. The browser resource controller analyzes rendered content of a web application to generate the complexity metric values that represent the complexity of the web application. The browser resource controller also compares executable elements from the web application with exploitative code components from code repositories to determine an exploitative code risk. The browser resource controller determines a resource consumption limit for a web application based on both the exploitative code risk and the complexity metric values and compares the resource consumption limit to a detected resource consumption value. If the browser resource controller determines that detected resource consumption exceeds its corresponding resource consumption limit, the browser resource controller reduces the resource consumption of the web application.

### FIELD OF USE

The disclosure generally relates to the field of information security, and more particularly to detecting and preventing exploitative behavior of applications.

### BACKGROUND

Client systems running a browser include a system task manager and a browser task manager. Typically, a system task manager tracks the consumption of client system resources and the process identifier (PID) associated with the resource consumption. A browser task manager associates the activity of web pages in the browser (e.g., in different tabs or windows of the browser) with at least one PID. A system task manager tracks and reports the use of computing resources such as central processing unit (CPU) use, random access memory (RAM) use, persistent memory (“disk memory”) use, network use, and graphics processing unit (GPU) use. The system task manager provides system metric values to other applications using an application programming interface (API).

A web application is a type of application that includes presenting components in a browser. A web application (such as a web page, a single page web application, a multi-page website, a smartphone-specific application, etc.) includes some combination of text, static graphics, multimedia components, and executable elements (such as Javascript® methods or classes) in a browser running on a client. In many cases, executable elements are loaded to automatically perform operations using client system resources. Many of these executable elements are used to perform activities that allow or improve a service offered by the web application, such as performing summations, regularly updating a health report, or changing a screen color to reflect a particular alert state.

### BRIEF DESCRIPTION OF THE DRAWINGS

Embodiments of the disclosure may be better understood by referencing the accompanying drawings.

FIG. 1 is a conceptual diagram of a browser resource controller analyzing the executable element and rendered contents of a web page to determine whether to limit the resource consumption of a process.

FIG. 2 is a Bayesian network representing an exploitative activity detector used by a browser resource controller.

FIG. 3 is a flowchart of example operations for protecting against exploitative resource consumption based on web application code and rendered content from the web application.

FIG. 4 continues from FIG. 3 with a flowchart of example operations for analyzing the executable elements of a web application to generate code metric values.

FIG. 5 includes representative screen captures of a web browser running a first tab including a video component, a second tab including an interactive simulation component, and a third tab including text and a static graphic.

FIG. 6 depicts an example computer system with a browser resource controller for prevention of exploitative resource exploitation.

### DESCRIPTION

Terminology

This description uses the term “application component” to refer to a standalone code unit (e.g., library file, standalone function, etc.) or a collection of code units. A collection of code units may refer to a library having multiple files or a package of files (e.g., compressed collection of files). An application component can be rendered into rendered content that is displayable onto a two-dimensional or three-dimensional display system (e.g. a computer screen, hologram, etc.). The term “multimedia component” refers to components that require more computational resources to process and display than a text component or a static graphic component. Examples of multimedia components include, but are not limited to, an interactive earth model simulation, a multi-dimensional game, a patient health user interface, a video stream, and/or a virtual reality application component. This description uses the term “throttle” to refer to the reduction of the rate of consumption of one or more computational resources by an application.

Overview

A web application (e.g. a web page, a single page web app, etc.) and its application components can reference variables and Javascript methods defined in an object. A particular Javascript method (“object method”) referenced in the application component can be necessary for performing activities to fulfill an application service (e.g., playing a video on the web page, updating a value in a health chart, etc.). An object method can also be used to perform one or more hidden activities, which uses client system computing resources without the knowledge of the client system user. While some of these hidden activities can be benign, some hidden activities are wasteful and/or harmful to the client system or its user. The program code used to perform the wasteful and/or harmful activity (“exploitative activity”) is a type of exploitative code stored in either an application component or a component in communication with the web application. One example exploitative activity includes controlling a client system to mine for digital currency without the knowledge of the client system user, which reduces the lifespan of the client system and wastes electric power to benefit a third-party entity without the permission of the client system user.

Because a modern web application can often require various hidden activities to perform or optimize user-desired services, a client system may run exploitative code without triggering an alert. Thus, a client system could be running harmful exploitative code while running a web application with a browser. While metric values of system resource use (“resource metric values”) can provide some evidence of exploitative activity, resource metric values are inadequate to distinguish exploitative hidden activities from benign hidden activities. Moreover, while static code analysis can provide code metric values based on code complexity and the probability of a web application's code being exploitative, the exploitative code can be obfuscated (e.g., renamed variables, re-organized code blocks, etc.) or linked to the web application via an external service, which can prevent detection of the exploitative code. Furthermore, ever-advancing changes in computing and internet technologies can render attempts to use strict correlations between code metric values and resource metric values counter-productive.

A browser resource controller is disclosed to combine code metric values with results from a complexity analysis of rendered content to determine whether one or more resource metric values are appropriate for a web application. The browser resource controller analyzes rendered content of a web application to generate metric values to represent the complexity of the web application and what a user would see when running the web page on the browser (“complexity metric values”). These complexity metric values either represent or are correlated with resource demands of different types content in the rendered content. In addition, the browser resource controller compares executable elements from the web application with exploitative code components from code repositories to determine an exploitative code risk. The browser resource controller determines a resource consumption limit for a web application (i.e. “allowable limit”) based on both the code metric values and the complexity metric values. The browser resource controller compares the resource consumption limit to the detected resource consumption as represented by one or more resource consumption related metric values. If the browser resource controller determines that detected resource consumption violates its corresponding resource consumption limit (e.g. greater than an upper limit, less than a lower limit, or otherwise exceeds an allowable limit), the browser resource controller reduces the resource consumption of the web application. For example, the browser resource controller can throttle processor use by the web application or stop the web application.

Example Illustrations

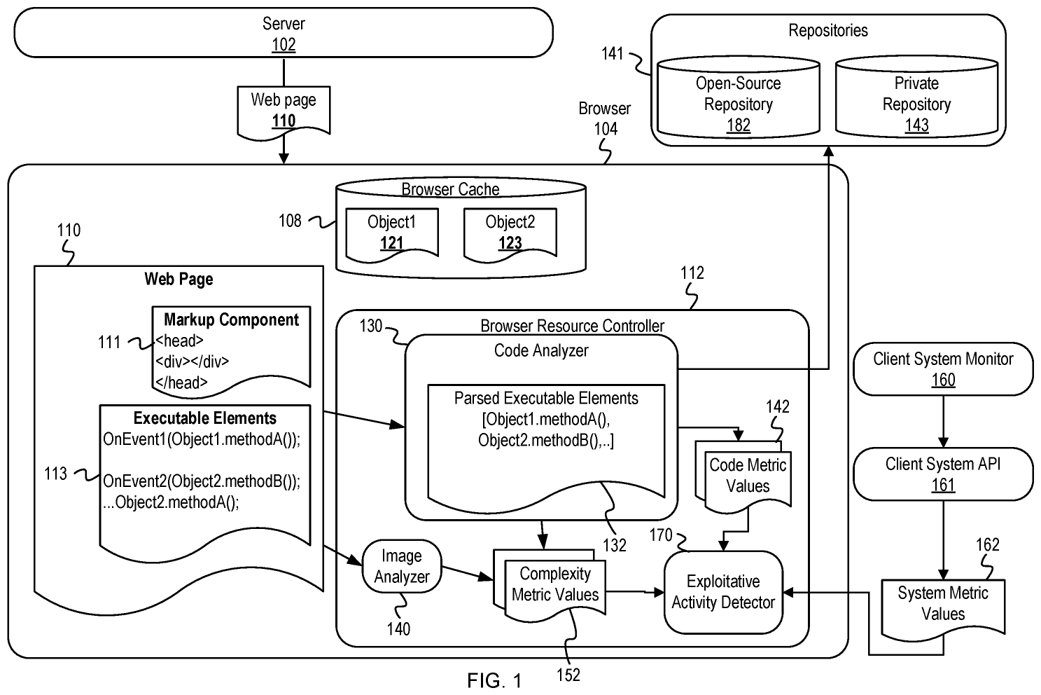

FIG. 1 is a conceptual diagram of a browser resource controller analyzing the executable elements and rendered contents of a web page to determine whether to limit the resource consumption of a process. A browser 104 interacts with a server 102 to initially retrieve a web page 110 and then continues to dynamically retrieve content of the web page 110. This content includes methods invoked within the web page 110. Some methods are not invoked unless a web page event occurs. Examples of web page events include selection of an item from a user interface component and satisfaction of a condition (e.g., passage of a defined amount of time). When content comes into scope of the browser 104, the content is loaded into a browser cache 108, which can be implemented into one or more of working memory such as random access memory (RAM) and disk memory. Objects loaded into the browser cache 108 can include multiple method definitions.

When the web page 110 is initially loaded, program code that instantiates a browser resource controller 112 is executed. The browser resource controller 112 can process the web page 110 as it is being downloaded and run by the browser 104 and also re-process the web page 110 in regular time intervals. In addition, the browser resource controller 112 includes options to re-process the web page 110 in regular time intervals and during significant changes in system resource consumption. The browser resource controller 112 includes a code analyzer 130 to deobfuscate (e.g. standardize variable names, standardize program code organization, etc.) and parse the executable elements 113 of the web page 110 into parsed executable elements 132. The code analyzer 130 then compares the parsed executable elements 132 with exploitative code found in repositories 141, which includes an open-source repository 182 and a private repository 143. The repositories 141 can explicitly or implicitly include indicators of exploitative code. For example, code having terms associated with exploitative behavior such as “cryptojacking” or “discrete mining” can be classified as exploitative code. The code analyzer 130 generates code metric values 142, which include a probability summarizing the risk that the web page 110 includes exploitative code (“summary exploitative code risk”) based on the comparisons with the repositories 141. Example code metric values can include the summary exploitative code risk, values used to derive the summary exploitative code risk, or other metric values such as a number of links to other web applications. Code metric values may also include characteristics of ingoing and/or outgoing communication traffic in the background from a web application. For example, crypto mining web applications periodically receive data (e.g. hashes) in the background and, after executing calculations, sends results to a server. Sent data can be sent in bigger volumes compared to received data over the course of repeated cycles. In such cases, code metric values may include a boolean value which indicates that a website communicates periodically with some servers. Code metric values may also include one or more indicators that one or more functions of a web application send data and wait for new incoming data.

In addition, an image analyzer 140 can use rendered content of the web page 110 and analyze its rendered text, rendered graphical components, and rendered multimedia components based on the web page 110. The image analyzer 140 can use content that is rendered by the browser 104 or generate its own rendered content, wherein its own rendered content may include additional modifications to increase the efficiency of the analysis. The image analyzer 140 uses the analysis of the rendered content to produce complexity metric values 152, which can include ratios such as the percentage of the web page that appears to be text, the percentage of the web page that appears to be part of a static image, and the percentage of the web page that appears to be part of one or more multimedia components. For example, the image analyzer 140 can apply optical character recognition (OCR) analysis to the rendered content in order to determine a percentage of the web page that appears to be text. In addition, the image analyzer 140 or another component of the browser resource controller 112 can classify interactive components in multimedia components. Image analysis can also compare rendered content from different time instances to distinguish between static elements and dynamic elements.

An exploitative activity detector 170 receives the code metric values 142, complexity metric values 152, and system metric values 162. The browser resource controller 112 obtains the system metric values 162 from a client system monitor 160 through a client system API 161 and include system resource consumption values such as the megabytes (MB) of RAM being used, the percentage CPU being consumed, etc. These values are associated with the browser process being run based on the web page 110. For example, the process being run by the browser 104 can have a processor identification (PID) of “01A” and the system metric values 162 can include the information that process “01A” is using 2 gigabytes (GB) worth of RAM. The exploitative activity detector 170 can then determine a remedial action based on a prediction system (e.g., rule-based prediction system, neural network prediction system, Bayesian network prediction system, etc.). For example, the exploitative activity detector 170 uses a Bayesian network prediction system to analyze the various metric values in order to determine a probability that a browser process based on the web page 110 is running exploitative code (“exploitation risk”). The browser resource controller then limits the browser process or stops the browser process if the exploitation risk is greater than an exploitation risk threshold.

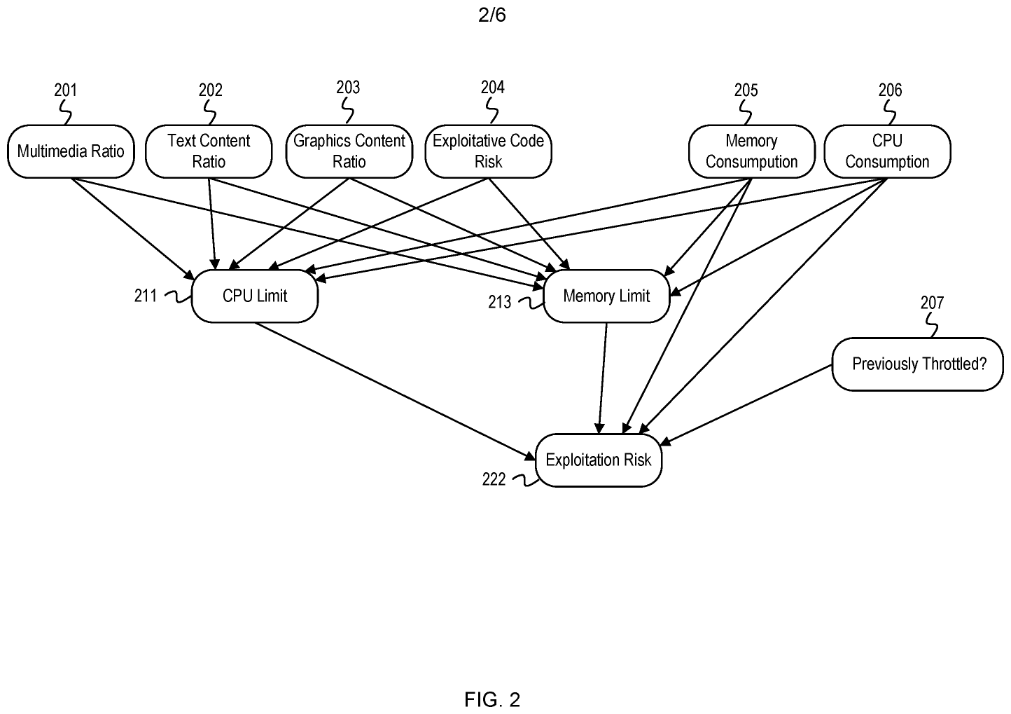

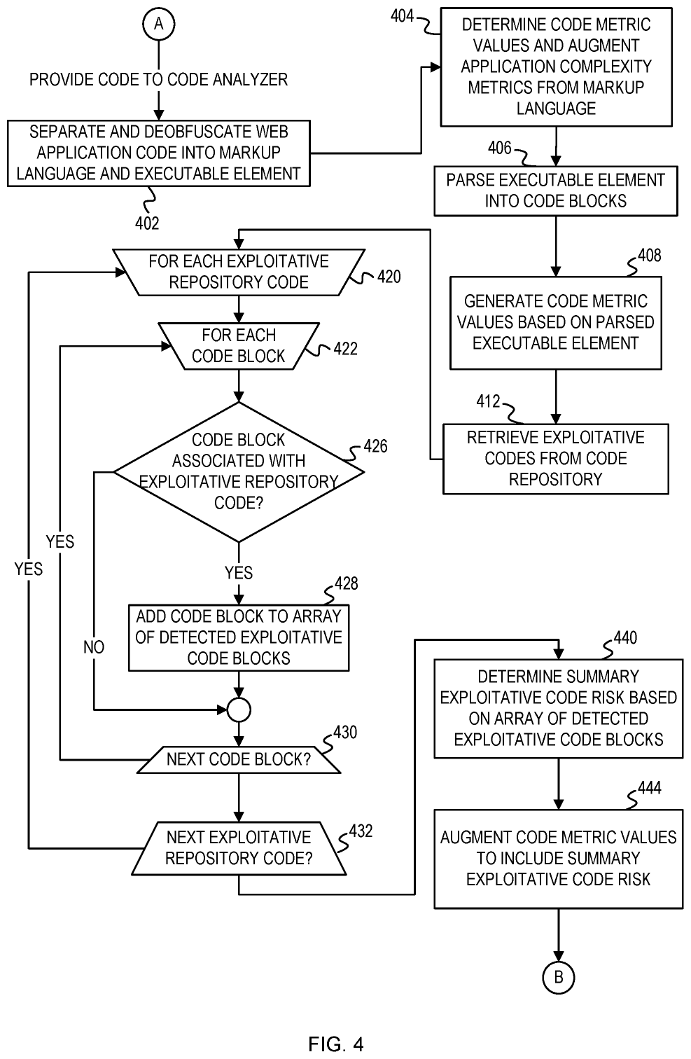

FIG. 2 is an example Bayesian network used to determine an exploitative risk for a web page or web application. The browser resource controller can collect complexity metric values and use them as input values for the multimedia ratio input node 201, text content ratio input node 202, and graphics content ratio input node 203. The browser resource controller can determine an exploitative code risk and use this risk as the input value for the exploitative code risk input node 204. As further described below in FIG. 4, the exploitative code risk can be a summary exploitative code risk. The browser resource controller can also use resource metric values as inputs for the memory consumption input node 205 and the CPU consumption input node 206. Each of the input nodes 201-206 can include converted ranges that allow the conversion of initial numeric input values into categorical values. For example, the ranges of [0.0-0.2), [0.2-0.6), and [0.6-1.0] can be set to “low,” “medium,” and “high,” respectively, wherein a numerical input value of 0.1 would be thus categorized as “low.” The browser resource controller also determines whether a resource consumption limit had been applied to a previous instance of the web application and uses the result of this determination as an input for the previously throttled input node 207.

Each of the input nodes 201-206 are linked to a CPU limit node 211 and a memory limit node 213. In some embodiments, categorical values from a node can be sent to another node as a numerical representation. For example, the categorical values of “low,” “medium,” and “high,” can be sent as the values 1, 2, and 3, respectively. During a determination of the resource consumption limits, results from the CPU limit node 211 are used to determine the CPU consumption limit and results from the memory limit node 213 are used to determine the memory consumption limit. In some embodiments, the probability weights for the CPU limit node 211 and memory limit node 213 can be 0.0, 1.0, or a value in the range of 0.0-1.0 with respect to the output from the input nodes 201-206. The CPU consumption limit can be determined based on one or more CPU likelihood thresholds and a regression value (e.g. a mean, variance, etc.) determined from the probability weights of the CPU limit node 211. The memory consumption limit can be determined based on one or more memory likelihood thresholds and a regression value determined from the probability weights of the memory limit node 213. For example, the browser resource controller can use the metric values for each of the input nodes 201-206 to generate probability distributions which show a 95% statistical confidence that the CPU consumption is less than 25% and that the memory consumption is less than 4 GB. If the confidence threshold is 95%, the browser resource controller can set the CPU consumption limit to 25% and the memory consumption limit to 4 GB for a particular web application.

The CPU limit node 211, memory limit node 213, and previously throttled input node 207 are each linked to the exploitation risk node 222. The previously throttled input node 207 can takes a value representing whether a previous instance of the web application had been throttled and then closed within a time interval threshold. The exploitation risk node 222 provides an exploitation risk based on the CPU consumption limit, memory consumption limit, and whether a previous consumption limit was applied. The exploitation risk can be provided in the form of a probability value such as 20%. In addition, the probability weights of each of the nodes can be modified based on preprogrammed responses to browser behavior. For example, in the case that multiple tabs are opened in a single browser or multiple browser windows are opened, the weights of the CPU limit node and memory limit node can be modified to reduce the CPU consumption limit and the memory consumption limit. Additionally, the probability weights of each of the nodes can be modified based on manual changes performed by a client system user and/or external updates to the browser resource controller. Once the exploitation risk is determined, the browser resource controller can determine whether nothing should be done, whether a web application corresponding with the exploitation risk should be limited, or whether the web application should be stopped.

In alternative embodiments, the browser resource controller can use a neural network or rules-based exploitative activity detector to determine the exploitation risk. The browser resource controller can then use the exploitation risk to determine an appropriate remedial action. For example, the browser resource controller can use a neural network that takes in the multimedia ratio, text content ratio, graphics content ratio, exploitative code risk, memory consumption, and CPU consumption as input values to determine a CPU consumption limit and an exploitative code risk.

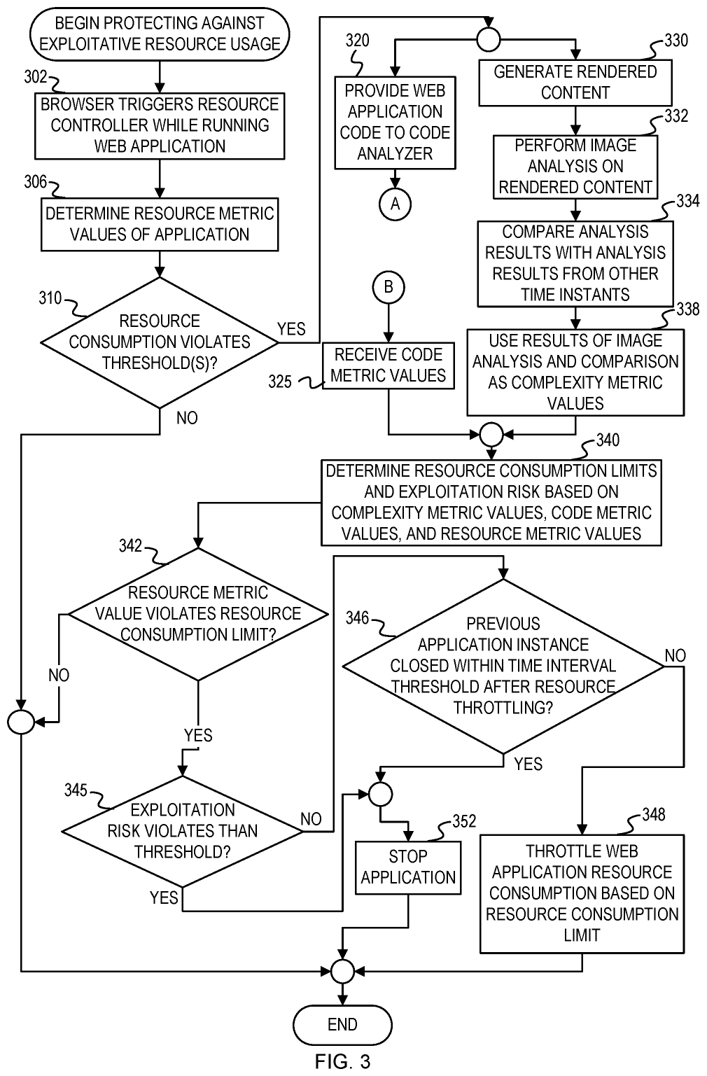

FIG. 3 is a flowchart of example operations for protecting against exploitative resource consumption based on web application code and rendered content from the web application. The example operations may be performed by the browser resource controller. Additionally, or alternatively, the example operations may be performed by other software components of the browser and/or a server.

During the runtime of a web application that has been loaded by a browser, a browser activates a browser resource controller (302). Embodiments can also launch the browser resource controller as a background process. The web application can be a web page loaded by the browser, an in-browser application downloaded from an online marketplace, a browser extension, etc. The browser resource controller determines resource metric values of the web application (306). The browser resource controller can determine the resource metric values by cross-referencing a PID of a tab or window running the web application with the resource consumption associated with that PID as measured by system task manager. For example, a browser tab having a PID of “001” can have RAM consumption ratio of 36% and a CPU consumption of 25%.

The resource controller will then determine if the resource consumption violates one or more thresholds (310). In some cases, a threshold can be set to an absolute value such as 1 gigabyte (GB) of RAM consumed. Alternatively, the default threshold can be defined as a relative value such as 5% of RAM consumed or 5% of processing power consumed. If the resource consumption does not violate the threshold(s), then the browser resource controller does not interfere with the web application.

If the resource consumption does violate a threshold, then the browser resource controller will provide code from the web application (“web application code”) to a code analyzer (320) and perform code analysis operations described further below in FIG. 4. In addition, the resource controller will generate rendered content (330) based on the web application code, wherein the rendered content can be modified (e.g., with simplified graphics, reduced coloring, etc.) to increase the efficiency of later image analysis. Alternatively, the resource controller can use rendered content generated by the browser instead of generating the rendered content itself. The rendered content can be a graphical depiction of the web application at a time instant. The browser resource controller performs image analysis such as OCR on the rendered content (332) to determine the complexity of the web application. The image analysis provides complexity metric values such as a ratio of text to non-text components and/or an absolute value of visual space filled with text. In one embodiment, the image analysis can first apply OCR to convert the image into a file having computer-readable text, split the image into equal-sized pixel sections, and determine which of the sections contain readable text or is part of an image. For example, using the embodiment described above, the resource controller can determine that a web application has a text section count to total section count ratio of 80% and a non-text section count to total section count ratio of 20%. In addition, the web browser controller compares analysis results of rendered content with analysis results from other rendering time instants to further classify the non-text components of the rendered content (334). Non-text components can include static graphics and multimedia components such as videos, interactive multi-dimensional simulations, virtual reality components, etc. For example, by comparing rendered content (or the analysis results) between two different time instants for each of the rendered content, the browser resource controller can determine whether a non-text component is a static graphic or a multimedia component. The browser resource controller can then use the results of the comparison and image analysis to as complexity metric values (338). These complexity metric values can directly include some combination of the content ratios described above (e.g., percentage of text to non-text components on a simulated screen, percentage of multimedia components, etc.). Alternatively, or in addition, complexity metric values can include absolute values corresponding to the amount of visual space taken by a component (e.g. 50 pixels by 100 pixels).

Once the browser resource controller generates the complexity metric values and generates/receives the code metric values (325), the browser resource controller will determine one or more resource consumption limits and an exploitation risk based on the complexity metric values, code metric values, and resource metric values (340). The resource metric values can include a summary exploitative code risk, as further described below in FIG. 4. With reference to FIG. 2, the browser resource controller can use the probability distributions determined at the nodes 211 and 213 to determine the resource consumption limits. Alternatively, or in addition, the browser resource controller can use a rule-based system or a neural network to determine the resource consumption limits and exploitation risk of the web application. One type of rule-based system can include instructions to use a conditional rule that sets one or more resource consumption limits based on a complexity metric value, such as setting a resource consumption limit based on whether a complexity metric value is less than a threshold value. For example, the rule-based system can use a conditional rule that sets a resource consumption limit to a maximum of 10% CPU consumption for any text content ratio greater than 90%.

The browser resource controller then determines whether a resource metric value violates a resource consumption limit (342). For example, the browser resource controller can determine that a CPU consumption of 25% corresponding with a web application violates the resource consumption limit of 10% for the web application. If no resource consumption limits are violated, the browser resource controller can proceed to take no action. If a resource consumption limit is violated (i.e. the resource consumption fails to satisfy the resource consumption limit), the browser resource controller determines if the exploitation risk violates an exploitation risk threshold (345). If the exploitation risk is greater than the exploitation risk threshold, the browser resource controller stops the web application (352). The browser resource controller can stop the application by directly stopping the process corresponding with the web application or by initiating the closure of a browser tab/window running the web application. In addition, the browser resource controller can record an identifier, such as a uniform resource locator (URL), associated with the web application in a data structure of closed web applications.

If the browser resource controller determines that the exploitation risk does not violate an exploitation risk threshold, the browser resource controller determines whether a previous instance of the web application had been closed within a time interval threshold after resource throttling (346). Such a determination is predictive of cases wherein throttling makes a web application difficult to use, prompting the automatic closure of the web application. Determining whether a previous instance of the web application had been closed can include determining whether a URL and elapsed time corresponding with the web application are stored in the data structure of closed web applications, wherein the elapsed time is a time between resource throttling and application closure, and wherein the elapsed time is less than a time interval threshold. The elapsed time can be tracked by the browser resource controller, wherein an elapsed time starting moment occurs when the browser resource controller begins throttling a web application (further described below). This time can be stored in the system browser cache or other system memory. For example, the resource controller can determine that it had previously throttled the resource consumption of a web application hosted at the URL “https://sURL.s36p478X3.bcazyx,” and that the web application was closed after the time interval threshold of one minute based on data available in the data structure of closed web applications. In response to this determination, the resource controller stops the web application (352). By either throttling or stopping the web application, the browser resource controller has reduced the resource consumption of the web application and curbed potentially exploitative activity.

If a previous application instance was not closed after resource throttling within a time interval threshold, the browser resource controller throttles web application resource consumption based on one or more resource consumption limits (348). The resource consumption limits can include some combination of a limit on memory consumption, CPU consumption, GPU consumption, network consumption, etc. For example, the resource consumption limit can include limits that prevent a web application from using more than 15% of a processor and more than 100 MB of RAM, and the browser resource controller can throttle a web application such that it does not violate the resource consumption limits. The browser resource controller also begins to store an elapsed time starting moment, which can be used at block 346 described above for later determination of whether throttling or application closure is an appropriate remedial action.

FIG. 4 continues from FIG. 3 with a flowchart of example operations for analyzing the executable elements of a web application to generate code metric values. The browser resource controller separates and deobfuscates the web application into one or more executable elements and a markup component (402). The markup component provides a set of instructions for text and/or graphic appearance and the executable element(s) (e.g., script) provides various instructions for the client system to run. The browser resource controller determines code metric values and augments the complexity metric values based on the markup component (404). For example, the web resource controller can use the hypertext markup language (HTML) component of a web page to determine that the web page includes components for four static graphics, five multimedia components, and 1000 words, and determine that the web page should be 25% text, 40% static graphics, and 35% multimedia components. In addition, the HTML component can be analyzed to determine a number of links to other web applications and include this number in the code metric values. In the case that the web application dynamically loads components (e.g. single page web applications), some embodiments of the browser resource controller attempt to forcibly load all of the components as a web application is rendered. In some alternative embodiments, the browser resource controller iteratively determines/modifies code metric values while either the browser or the browser resource controller generates new rendered components as the web application is being used. In further alternative embodiments, the markup component-based complexity metric values are not generated or ignored for web applications that dynamically load components. This information can be combined with the complexity metric values described above using a weighted average or a more advanced method.

The browser resource controller parses the executable element(s) into code blocks (406). The code blocks can be based on elements of a syntax tree (i.e. parse tree) generated during the parsing of the executable element(s). In addition, the browser resource controller generates code metric values based on the parsed executable elements (408). For example, the browser resource controller can generate an initial estimate of an exploitation risk based on the parsed executable element including links to known exploitative websites and/or servers.

The browser resource controller accesses a code repository to retrieve a set of exploitative repository codes from the code repository (412). In some embodiments, the code repository can be an internal non-open source code repository or an external open source code repository. More than one code repository can be accessed. In addition, the browser resource controller determines the likelihood that the code block is associated with exploitative repository code. In some embodiments, the code repository includes a data entry or tag associated with the repository code that explicitly labels the repository code as exploitative. Alternatively, the code, code title, or tags associated with the code can include specific characters, words, or phrases that the browser resource controller recognizes as exploitative. These specific characters, words, and phrases are types of strings associated with their respective code in the code repository. For example, the browser resource controller can determine that a commented portion of a repository code found in a code repository includes the phrase “monero clone,” recognize the string as one associated with exploitative code and label the repository code as exploitative repository code.

For each available exploitative repository code found in the one or more code repositories (420) and each code block from the deobfuscated executable element (422), the browser resource controller determines whether the code block is associated with exploitative repository code (426). The browser resource controller can determine whether the code block is associated with exploitative repository code by determining a percentage similarity between the code block and each of the one or more exploitative repository codes and use the percentage similarity as an exploitative code risk associated with the code block to compare against a difference threshold. For example, the browser resource controller can determine a per-word sequential difference between a code block from a deobfuscated executable element and a code block from the exploitative repository code and determine that the per-word percentage similarity is 90%. If the difference threshold is 85%, the code block is associated with exploitative code and has an associated exploitative code risk equal to its similarity (i.e. 90%). Each of the code blocks determined to likely be exploitative code are then added to the array of detected exploitative code blocks (428). Furthermore, each of the detected exploitative code blocks can also have their respective associated exploitative code risks added to the array.

If there are additional code blocks to be analyzed (430), the browser resource controller proceeds to the next code block. If there are additional exploitative repository codes to use for comparison (432), the browser resource controller proceeds to the next exploitative repository code. Once the available code blocks and exploitative repository codes are processed, the browser resource controller determines a summary exploitative code risk based on the array of exploitative code blocks (440). In some embodiments, the browser resource controller determines that the summary exploitative code risk is equal to the greatest value from the exploitative code risks associated with each of the exploitative code blocks. Alternatively, the browser resource controller can use a weighted sum of the exploitative code risks to determine the combined exploitative code risk. For example, the browser resource controller can weight each of the exploitative code risks by the length of the code block associated with them and then sum the weighted exploitative code risks to determine a combined exploitative code risk. Once the summary exploitative code risk is calculated, the code metric values can be augmented to include the summary exploitative code risk (444). These code metric values can then be used as disclosed in FIG. 3.

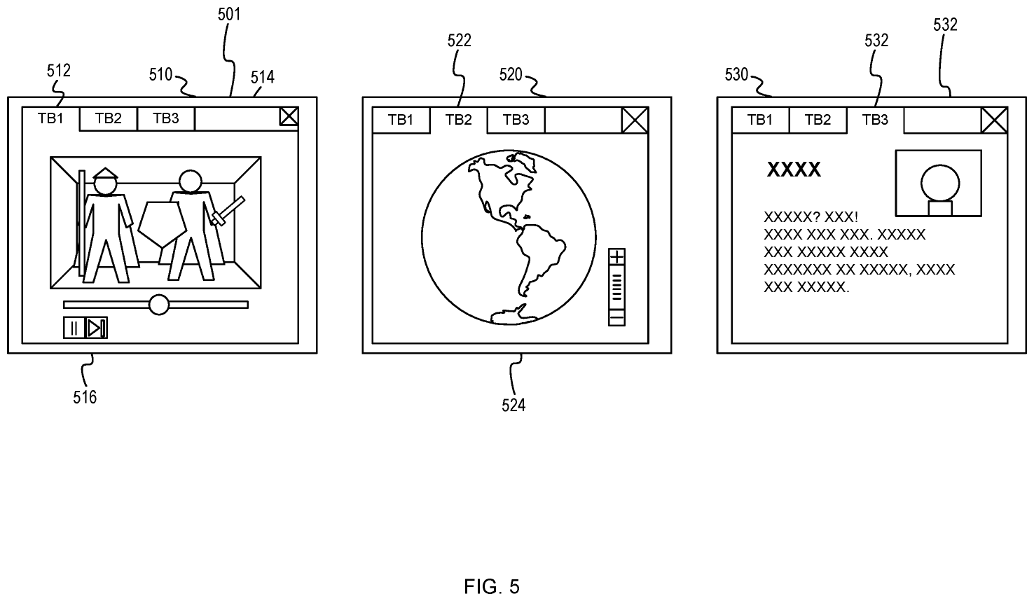

FIG. 5 includes representative screen captures of a web browser running a first tab including a video component, a second tab including an interactive simulation component, and a third tab including text and a static graphic. The screen capture 510 depicts a first tab 512 of a web browser 501. The first tab is running a video, which a multimedia component, and is labeled accordingly as a multimedia component using time-lapse image recognition analysis. The screen capture 520 depicts a second tab 522, which includes an interactive global simulation 524. The interactive global simulation 524 is also a multimedia component. The screen capture 530 depicts a third tab 532, which includes primarily text components and a static graphic 534.

A browser resource controller can be an extension to the web browser 501 and either directly or indirectly measures the performance of the processes corresponding to each of the tabs 512, 522, and 532. For example, the browser resource controller can use an API to communicate with the system resource controller to determine the individual resource consumption in terms of CPU consumption and RAM consumption for each browser tab. In addition, the browser resource controller applies an image analyzer to determine complexity metric values that include a webpage text space percentage, static graphic percentage, and multimedia component percentage. Furthermore, the browser resource controller can determine the exploitative code risk for each of the tabs. The browser resource controller can use a Bayesian network to determine whether to allow the tab of each browser to continue running without any limits, limit the resources a webpage running on a particular tab is allowed to consume, or stop a webpage entirely. An example of the particular inputs and decisions made by a browser resource controller using a Bayesian network is shown below in Table 1:

TABLE 1

| | Resource | Complexity | Summary | Resource | |
|---|---|---|---|---|---|
| | Metric | Metric | Exploitative | Consumption | Remedial |
| App | Values | Values | Code Risk | Limit Values | Action |
| TB1 | CPU: 45% | Text: 20% | 95% | CPU: 40% | Stop: |
| | RAM: 4 GB | Static | | RAM: 2 GB | True |
| | | Images: 10% | | | Throttle: |
| | | Multimedia | | | True |
| | | Components: | | | |
| | | 70% | | | |
| TB2 | CPU: 45% | Text: 15% | 0% | CPU: 50% | Stop: |
| | RAM: 4 GB | Static | | RAM: 5 GB | False |
| | | Images: 5% | | | Throttle: |
| | | Multimedia | | | False |
| | | Components: | | | |
| | | 80% | | | |
| TB3 | CPU: 15% | Text: 90% | 50% | CPU: 5% | Stop: |
| | RAM: 1 GB | Static | | RAM: 2 GB | False |
| | | Images: 10% | | | Throttle: |
| | | Multimedia | | | True |
| | | Components: | | | |
| | | 0% | | | |

As shown above in Table 1, each tab is running a separate web application which can be correlated with different amounts of resource consumption as show in the column “Resource Metric Values.” The browser resource controller analyzes each tab and a ratio of their text, static graphic components, and multimedia components relative to the total visual space available on a screen. In addition, the browser resource controller analyzes the executable element to determine an exploitative code risk. Based on the complexity metric values and the exploitative code risk, the browser resource controller can apply a Bayesian network to determine an appropriate resource use for each web page. For example, with reference to FIG. 2, the Bayesian network can determine a CPU consumption limit at the CPU limit node 211 and a memory consumption limit at the memory limit node 213. Based on at least one of a CPU consumption exceeding the CPU consumption limit or the memory consumption exceeding the consumption limit, the browser resource controller can determine that a resource metric value violates a resource consumption limit. The browser resource controller further determines whether to throttle the web application or to stop the web application completely. For example, as shown for the row in Table 1 for the web application TB1, the resource metric values are shown as including a CPU consumption of 40% and RAM consumption of 2 GB. Based on the complexity metric values and the summary exploitative code risk for TB1, the browser resource controller determines that the resource consumption limit for TB1 is a CPU consumption limit of 45% and a RAM consumption limit of 4 GB, and that the exploitation risk is 95%. If the exploitation risk threshold is 65%, the browser resource controller would stop the web application TB1 because the exploitation risk violates the exploitation risk threshold.

For another example, as shown for the row in Table 1 for the web application TB2, the resource metric values are shown as having a CPU consumption of 45% and RAM consumption of 4 GB. However, based on the complexity metric values and the summary exploitative code risk for TB2, the browser resource controller determines that the resource consumption limit for TB2 is a CPU consumption limit of 50% and a RAM consumption limit of 5 GB. Neither the CPU consumption limit of 50% nor the RAM consumption limit of 5 GB are violated by their respective resource metric values. If no other resource consumption limits are violated, the browser resource controller would not stop or throttle the web application TB2.

For a third example, as shown for the row in Table 1 for the web application TB3, the resource metric values are shown as having a CPU consumption of 15% and RAM consumption of 1 GB. However, based on the complexity metric values and the summary exploitative code risk for TB3, the browser resource controller determines that the resource consumption limit for TB3 is a CPU consumption limit of 5% and a RAM consumption limit of 2 GB, and that the exploitation risk is 50%. Because the CPU consumption of 15% violates the CPU consumption limit of 5%, the browser resource controller will perform a remedial action. If the exploitation risk threshold is 65%, the exploitation risk is less than the exploitation risk threshold. Thus, the browser resource controller would throttle the web application TB3 to its resource consumption limits because a resource metric value violates its corresponding resource consumption limit, but the exploitation risk is less than the exploitation risk threshold.

Example Computer Devices

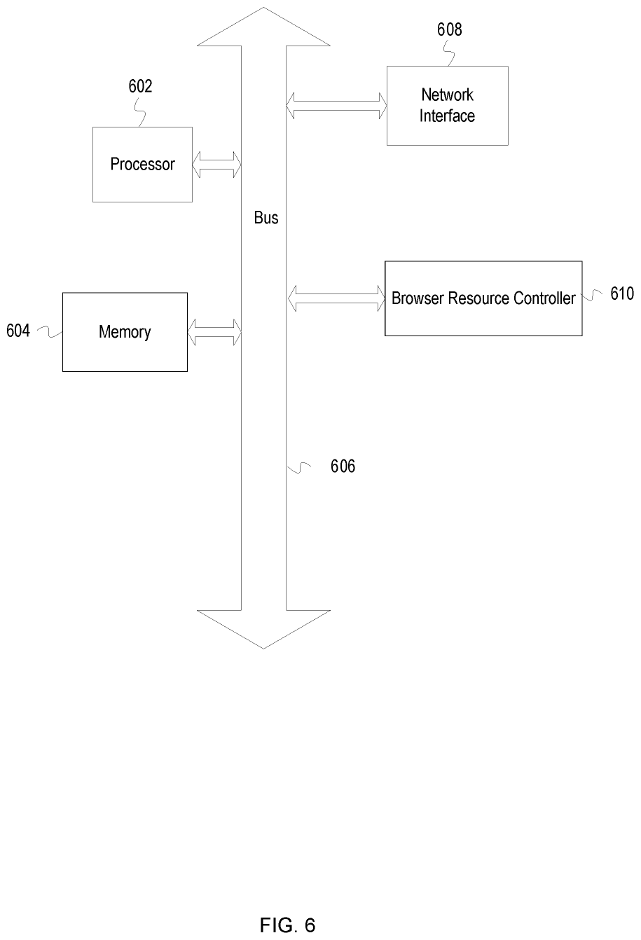

FIG. 6 depicts an example computer system with a browser resource controller for prevention of exploitative resource exploitation. In some examples, the computer system may be a part of the host on which the browser resides. The computer system includes a processor 602 (possibly including multiple processors, multiple cores, multiple nodes, and/or implementing multi-threading, etc.). The computer system includes memory 604. The memory 604 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, magnetic memory, etc.) or any one or more of the above already described possible realizations of machine-readable media. The computer system also includes a bus 606 (e.g., PCI, ISA, PCI-Express, HyperTransport® bus, InfiniBand® bus, NuBus, etc.) and a network interface 608 (e.g., a Fiber Channel interface, an Ethernet interface, an interne small computer system interface, SONET interface, wireless interface, etc.). The system also includes a browser resource controller 610 for determining whether one or more resource metric values of a client system are too great for a web application. The browser resource controller 610 also throttles a web application based on a resource consumption limit and/or stops the web application if one or more resource metric values violate the resource consumption limit. Any one of the previously described functionalities may be partially (or entirely) implemented in hardware and/or on the processor 602. For example, the functionality may be implemented with an application specific integrated circuit, in logic implemented in the processor 602, in a co-processor on a peripheral device or card, etc. Further, realizations may include fewer or additional components not illustrated in FIG. 6 (e.g., video cards, audio cards, additional network interfaces, peripheral devices, etc.). The processor 602 and the network interface 608 are coupled to the bus 606. Although illustrated as being coupled to the bus 606, the memory 604 may be coupled to the processor 602.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) (or media) may be utilized. The machine-readable medium may be a machine-readable signal medium or a machine-readable storage medium which is non-transitory. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any non-transitory tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that can communicate, propagate, or transport a program for use by or in connection with an instruction execution system, apparatus, or device, but is not a machine-readable storage medium.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

While the aspects of the disclosure are described with reference to various implementations and exploitations, it will be understood that these aspects are illustrative and that the scope of the claims is not limited to them. In general, techniques for dynamic instrumentation as described herein may be implemented with facilities consistent with any hardware system or hardware systems. Many variations, modifications, additions, and improvements are possible.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
analyzing rendered content of a web application to determine a complexity metric value representing a predicted resource demand of the web application based, at least in part, on a type of content rendered from the web application;
determining a resource consumption limit based, at least in part, on the complexity metric value;
determining whether resource consumption of the web application violates the resource consumption limit; and
reducing resource consumption of the web application based, at least in part, on a determination that the resource consumption of the web application violates the resource consumption limit.

2. The method of claim 1, wherein the complexity metric value is a first complexity metric value, and wherein determining the resource consumption limit comprises determining the resource consumption limit with a Bayesian network that comprises a first input node for the first complexity metric value and a second input node for a second complexity metric value, wherein the second complexity metric value represents a second resource demand of a second type of content of the web application.

3. The method of claim 1, wherein analyzing the rendered content comprises determining the complexity metric value based, at least in part, on an amount of text in the rendered content.

4. The method of claim 3, wherein analyzing the rendered content further comprises determining the amount of text in the rendered content based, at least in part, on performing optical character recognition on the rendered content.

5. The method of claim 1, wherein reducing resource consumption of the web application comprises at least one of stopping the web application and throttling resource consumption of the web application.

6. The method of claim 5, wherein reducing resource consumption further comprises:
determining that throttling the resource consumption of the web application had been performed previously;
determining that the web application was stopped within a time interval threshold after the previous throttling; and
stopping the web application.

7. The method of claim 1, further comprising determining an exploitative code risk for an executable element of the web application, wherein determining the resource consumption limit is also based, at least in part, on the exploitative code risk.

8. The method of claim 7, wherein determining the exploitative code risk comprises:
generating a syntax tree based, at least in part, on the executable element of the web application;
receiving a set of components of exploitative code from a code repository; and
comparing components of the syntax tree with the set of components of exploitative code to determine a similarity, wherein the exploitative code risk is based, at least in part, in part on the similarity.

9. The method of claim 8, further comprising:
deobfuscating the executable element; and
deobfuscating the set of components of exploitative code, wherein comparing the components of the syntax tree with the set of components of exploitative code comprises comparing deobfuscated components of the syntax tree with deobfuscated components of exploitative code.

10. The method of claim 1, wherein analyzing the rendered content comprises determining the complexity metric value based, at least in part, on an amount of static graphics in the rendered content.

11. The method of claim 1, further comprising:
analyzing the rendered content to determine a second complexity metric value representing a resource demand of an amount of multimedia content,
wherein determining the resource consumption limit is also based on the second complexity metric value.

12. One or more non-transitory machine-readable media comprising program code, the program code comprising instructions to:
determine a set of complexity metric values, the set of complexity metrics comprising a first value representing an expected resource consumption for a web application based, at least in part, on different types of content rendered from the web application;
determine a second value for an executable element of the web application, wherein the second value represents risk that the executable element is exploitative code;
determine a resource consumption limit based on the set of complexity metric values and the exploitative code risk;
determine whether resource consumption of the web application violates a resource consumption limit based, at least in part, on the first and second values; and
perform a remedial action that reduces resource consumption of the web application based, at least in part, on a determination that the resource consumption of the web application violates the resource consumption limit.

13. The one or more non-transitory machine-readable media of claim 12, wherein the program code to determine the resource consumption limit comprises instructions to determine the resource consumption limit with a Bayesian network that comprises a first input node for one of the set of complexity metric values and a second input node for the exploitative code risk.

14. The one or more non-transitory machine-readable media of claim 12, wherein the resource consumption limit is one of a limit on processor consumption or memory consumption.

15. The one or more non-transitory machine-readable media of claim 12, wherein the remedial action comprises at least one of an action to stop the web application and an action to throttle resource consumption of the web application.

16. An apparatus comprising:
a processor;
a network interface; and
a machine-readable medium comprising instructions executable by the processor to cause the apparatus to,
determine a complexity metric value representing resource demands of a content type in rendered content from a web application;
calculate an exploitative code risk for an executable element of the web application;
determine an allowable limit on resource consumption based on the complexity metric value and the exploitative code risk;
determine whether resource consumption of the web application violates the allowable limit on resource consumption; and
reduce resource consumption of the web application based, at least in part, on a determination that the resource consumption of the web application violates the allowable limit on resource consumption.

17. The apparatus of claim 16, wherein the instructions to determine the allowable limit comprises instructions executable by the processor to cause the apparatus to determine the allowable limit using a conditional rule, wherein a condition of the conditional rule is based on the complexity metric value.

18. The apparatus of claim 16, wherein the instructions to determine the complexity metric value comprises instructions executable by the processor to cause the apparatus to determine the complexity metric value based, at least in part, on an amount of text in the rendered content.

19. The apparatus of claim 16, wherein the instructions to reduce resource consumption of the web application comprises at least one of instructions to stop a process associated with the web application, instructions to close a tab associated with the web application and instructions to close a web browser.

20. The apparatus of claim 16, wherein the instructions to determine the exploitative code risk further comprises instructions to:
parse the executable element of the web application into a parse tree;
receive a set of components of exploitative code from a code repository; and
compare components of the parsed tree with the set of components of exploitative code to determine a similarity, wherein the exploitative code risk is based, at least in part, in part on the similarity.
